(19) United States
(12) Patent Application Publication
(10) Pub. No.: US 2003/0078032 A1
(43) Pub. Date: Apr. 24, 2003

(54) Remote control based on a wireless message service

(75) Inventors: Sun Pei, Beijing (CN); Shen Jun, Beijing (CN); Song Song, Beijing (CN); Li Tao, Beijing (CN)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 10/243,522

(22) Filed: Sep. 13, 2002

(30) Foreign Application Priority Data
Sep. 21, 2001 (CN) 01140814.6

(51) Int. Cl. H04M 1/66; H04Q 7/20; H04M 1/68; H04M 3/16; H04M 3/00

(52) U.S. Cl. 455/411; 455/466; 455/419

(57) ABSTRACT

Remote control apparatus, systems and methods based on a wireless message service. In an example embodiment, the system includes transmitting means for transmitting a wireless message and receiving means for receiving the wireless message. It has a control application server which has security checking means for ensuring safety of the system, command generator for generating a control command as a function of the received wireless message and communication means for transferring the control command to a device to be controlled. The control command is transferred to the device through a network.

### FIELD OF THE INVENTION

This invention relates to the field of remote control, and in particular, to remote control apparatus, systems and methods based on a wireless message service.

### BACKGROUND OF THE INVENTION

The traditional remote control is usually based on leased lines or proprietary networks. Because of the high cost of the communication medium, its usage is limited to critical industrial applications. With the wide spread of the Internet, remote control and tele-instrumentation via the Internet have emerged and become more and more popular. The ease of use and the low cost of Internet-based remote control allow the consumer products such as refrigerators, washing machines, air conditioners and TV sets to be remotely controlled, stimulating the emergence of Home Internet Appliance (HIA). The user can manipulate a HIA through the web browser. However, this application scenario exhibits several problems. Firstly, the computer with which the control is carried out is usually a stationary PC connected to a wired network. It cannot be carried around. Even with the laptops or handheld PCs, the wired network is still required. This limits the accessibility of such services and restricts the scope of the application. Secondly, the cost of the PCs or laptops is high.

The recently developed WAP-enabled mobile phone incorporates a relatively simple micro-browser to the mobile phone and can be used in the Internet-based remote control. It partly solves the above problems by improving the accessibility to the Internet. However, the WAP service requires special type of mobile phones and the cost thereof is relatively high.

In addition, U.S. Pat. No. 6,275,710 B1 issued on Aug. 14, 2001 discloses a system for remote metering and control based on a short message service. However, the security of the system is poor and the control relationship is one to one correspondence, i.e., one control unit can be used to control only one target apparatus.

### SUMMARY OF THE INVENTION

Therefore, one aspect of the invention is to provide remote control apparatus, systems and methods which can be implemented with relatively low cost and which are of high security.

A further aspect of the invention is to improve the availability of the system and method for remote control service, so that the method and/or system can be used to realize centralized control of a plurality of targets.

To achieve the aspects of the invention as above, there is provided a remote control apparatus, system and method based on the short message service. The remote control system and method is of high security and can be used to realize centralized control of a plurality targets.

Firstly, there is provided an example of a remote control system based on a wireless message service, comprising transmitting means for transmitting a wireless message, and receiving means for receiving the wireless message. It includes a control application server which has security checking means for ensuring safety of the system, a command generator for generating a control command as a function of the received wireless message, and communication means for transferring the control command to a device to be controlled.

Secondly, there is provided a remote control method based on a wireless message service. An example embodiment includes the following steps: transmitting a wireless message; and receiving the wireless message. It further includes the steps of checking security properties of the wireless message, generating a control command as a function of the received wireless message and transferring the control command to a device to be controlled.

In some embodiments, a user can send a short message via a mobile phone (it will be appreciated through the description hereinafter that it is not limited to mobile phones in the invention, any devices which can be used transmit a short message can be employed.) to achieve a specific remote control purpose. The system and method according to the invention provides a robust, low-cost and highly available application environment. Firstly, it is noted that several popular wireless communication standards support SMS (Short Message Service) around the world, including GSM900/1800/1900, TDMA/D-AMPS, CDMA, etc. An ordinary cellular phone can be used to access SMS, eliminating the requirement of the wired network access as well as the WAP-supported network access. The remote control functions can be performed anywhere as long as the short message service is supported. Secondly, the SMS guarantees message delivery. A sender is notified whether or not a short message is successfully transmitted, and the short message can be forwarded to a receiver even if the receiver is powered off or cannot receive the short message temporally; the short message will be stored in the short message service center until the receiver is able to receive it. This enhances the robustness of the remote control system and method according to the present invention. In addition, SMS provides bi-directional message delivery. The remote control not only can be the control operation from the operator side but also can be the information sent by the home side for example, the result of HIA status query or the notification message pushed by the home side. Thirdly, compared with PCs and WAP-enabled mobile phones, the ordinary mobile phones and the short message service are much cheaper and affordable to the user. Finally, the access interface is generally simpler to the ordinary user.

Thus, the advantages of this invention include:

1. The SMS-based remote control system and method greatly improves mobility and availability of the Internet-based HIA remote control, eliminating the restriction imposed by the wired network and stationary access device;

2. The SMS-based remote control system and method provides a low-cost solution to the HIA remote control, which is critical to the popularity of the service;

3. The SMS-based remote control system and method provides a two-way communication control mechanism;

4. The short message interface is familiar to ordinary people and may encourage them to use the service;

5. The system is of high security according to the invention, with a secure module employed in the system; and

6. Both a control command generator and a control command transmitter are employed according to the invention to implement centralized control of a plurality of targets.

### BRIEF DESCRIPTION OF THE DRAWINGS

The foregoing and other aspects of these teachings are made more evident in the following detailed description of the invention, when read in conjunction with the attached drawing figures, wherein:

FIG. 1 shows an example of the architecture for SMS-based HIA remote control in accordance with the invention;

FIG. 2 shows an example of a scenario of SMS-based HIA remote control according to a advantageous embodiment of the invention; and

FIG. 3 is a flow chart illustrating a method for SMS-based remote control according to a advantageous embodiment of the invention.

### DETAILED DESCRIPTION OF THE INVENTION

The remote control method and system in accordance with the present invention will be described with reference to an example concerning how to implement remote control for HIA. However, it should be appreciated by persons skilled in the art that this invention can be applied in other remote control fields. Further, though a term “control” is frequently used in the following description, the term “control” herein refers to general control operation and collection (measurement) of status information.

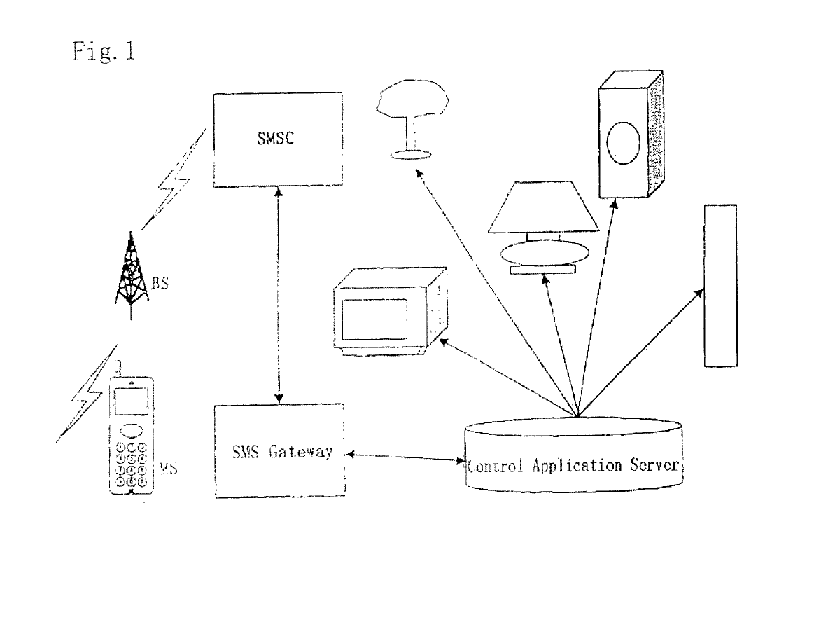

FIG. 1 shows an example of the architecture for SMS-based HIA remote control in accordance with the invention. As shown in FIG. 1, an example embodiment of a system according to the present invention includes a short-message service side and a control side. The short-message service side has a mobile terminal acting as a control terminal MS, a base station BS and a short message service center SMSC. The short message service side is well known to persons skilled in the art and detailed description thereof will be omitted. The control side includes a SMS gateway, a control application server and apparatus to be controlled (including, for example, air conditioners, TV set, refrigerator, and electric light). The SMS Gateway acts as a bridge between the SMSC and the Control Application Server. It provides a communication interface to both sides and is responsible for necessary format conversion between them. The SMS Gateway can be as simple as a device capable of transmitting and receiving short messages, such as a normal mobile phone. The structure of the SMS Gateway is well known to persons skilled in the art. Of course, the SMS Gateway will transfer the received short message to the control application server and transmit short messages generated by the control application server to the user. This is also well known to persons skilled in the art. Alternatively, the SMS Gateway may be a dedicated device connected through a leased line/wire to the SMS center.

In another embodiment, the SMS Gateway may constitute a part of the SMS service center such that message throughout can be increased dramatically. The SMS Gateway and the control application server may be integrated as a single device, and alternatively, they may be separate devices communicating with each other in appropriate communication modes. Advantageously, in a case where the SMS Gateway and the control application server are separated, they are connected through a network (for example, Internet, LAN, and etc.). Alternatively, they are connected through a leased line. In another embodiment of the invention, a SMS Gateway may be associated with a plurality of control application servers (In such a case the SMS Gateway is advantageously collocated with the SMS service center). To implement the method of the embodiment, the control application servers may apply to the SMS service center for a specific service number for connection with the SMS Gateway, i.e., apply to the SMS service center for a specific service number for each of the plurality of the control application servers and obtain a communication line such a TCP/IP connection on Internet for connection with the SMS Gateway. Therefore, any message sent to the specific service number will be transferred to the SMS service center, to the SMS Gateway, and then to a corresponding control application server through the Internet.

The control application server receives a remote control request from the SMS Gateway. The control application server translates and interprets the remote control request and then generates a corresponding control command for HIA, which will be sent out through a communication channel/network. A particular structure of the control application server will be described in detail hereinafter.

Advantageously, apparatus to be controlled such as a TV set, a conditioner, and a refrigerator are connected to a network (including the Internet and a LAN), and the control application server and the apparatus to be controlled are connected through the network. Of course, it will be appreciated by persons skilled in the art that the apparatus to be controlled may not capable of being connected to a network. In such a case, the control application server may control the apparatus through a special control line. The special control line may be wireless or wired. In another embodiment, the control application server may transfer the control command to a sub control application server and the apparatus to be controlled will be under direct control of the sub control application server. It is well known to persons skilled in the art on how to control an apparatus and detailed description thereof is therefore omitted herein.

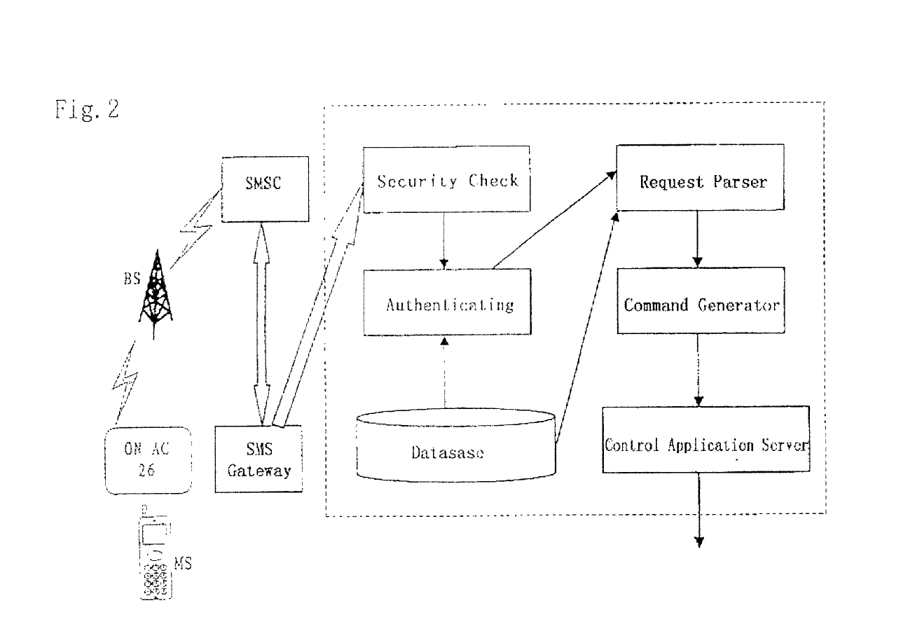

FIG. 2 shows an example of a scenario of SMS-based HIA remote control according to a advantageous embodiment of the invention. According to the advantageous embodiment of the invention, the control application server mainly comprises three sections: a security check section, a control command generator section, and a control command transferring section. As illustrated in the advantageous embodiment of the invention of FIG. 2, the security check section comprises security means and authentication means; the control command generator section comprises a request parser and a command generator; the control command transferring section comprises communication means; and a database is used to store any information useful for other components of the control application server. The function and operation of all components of the control application server will be described in connection with FIG. 2.

Security Means: Since the control application server is located between the public SMS gateway and the private HIA, the safety issue is critical to the safety of private property. According to the invention, the security means is responsible for protecting the control application server from a malicious access. Special devices such as a STK card, a SMART card, or a java card can be attached to the portable devices. One of the functions of these cards is to have the data to be transmitted encrypted. After the encrypted data reach the control application server, they are decrypted by the security means through pre-agreed on decryption arithmetic such that only valid control requests can pass through the security means and be sent to the following authentication means.

Authentication Means: The authentication means checks the validity and limits of authority of the requester. The authentication means is used to refuse malicious accesses mainly based on the origin of the control requests, the user name and the user's password. For example, depending on the setup of the system, the control application server may only accept short messages/control requests from particular calling phone numbers. Alternatively, the control application server may perform control based on the user name and the password. Only if both the user name and the password are correct, can the user transmit a control request. If the control application server fails to receive control requests from the user for a continuous period of time, for example 5 minutes, the control application server may invalidate this time of log on; that's to say, if the user intends to continue to transmit control request, the user has to log on again. The system can also be set up as such that if a control request comes from a mobile terminal having a particular phone number, the log on procedure is not necessary; otherwise, the user name and the password are required to log on, and if the control application server fails to receive a valid control request during a continuous period of time, for example 5 minutes, after the user logged on, this time of log on will be invalidated. Valid mobile telephone numbers, user names and passwords, and limits of authority for different users may be pre-stored in the database means. advantageously, a user is identified by an identification number unique to the portable device (for example a mobile phone) of the user. To enhance the security, the control party may be asked to input a password to ensure that the user who uses the portable device to perform a control is an authorized one. Limits of authority for respective users are stored in the database of the control application server. The security means with the authentication means work together to ensure the security and authorization issue for the HIA remote control based on SMS. The request pass through the authentication is transferred to the following request parser for translation and interpretation.

Request Parser: The request issued from the mobile phone must be concise because of the limited input capability of the mobile phone and of the limitation to the length of the short message. Therefore, the request conveyed by a short message and the corresponding command causing the control action to the HIAs are rather different, and a translation between them is needed. The request parser is responsible for analyzing the syntax and semantics of the request. Much of the prior knowledge required by the Request Parser can be stored on the database means. If the request is properly analyzed, the request will be transferred to a command generator; otherwise, an error message may be generated and fed back to the user of the mobile terminal through the SMS Gateway and the SMS center. After passing the authentication, the system acquires the limits of authority to control the apparatus. The limits of authority represent which apparatus the portable device (the subscriber) is authorized to control. The address of the apparatus to be controlled or the address of the Gateway thereof is also preset in the database means. These addresses are actually network addresses and can be addressed by means of addressing modes commonly used in networks. The addresses are transmitted in a short message to the control application server as a parameter of the control information. Of course, instead of being in a form of actual address, the addresses can be specified by predetermined semantics.

Control Command Generator: Due to the diversity of the home network and the HIAs, currently, there is no unique worldwide standard for HIA control commands. The control command is HIA specific. The control command generator generates the HIA control commands using the parameters parsed from the request parser.

Communication Means: The communication means provides the access both to the short message gateway and to the HIAs, to transmit certain status messages to the user via the short message gateway and to control the HIAs.

Database Means: The database keeps the persistent data including the management information, history records, the service policy and so on. It provides indexed information to other means and stores operation logs.

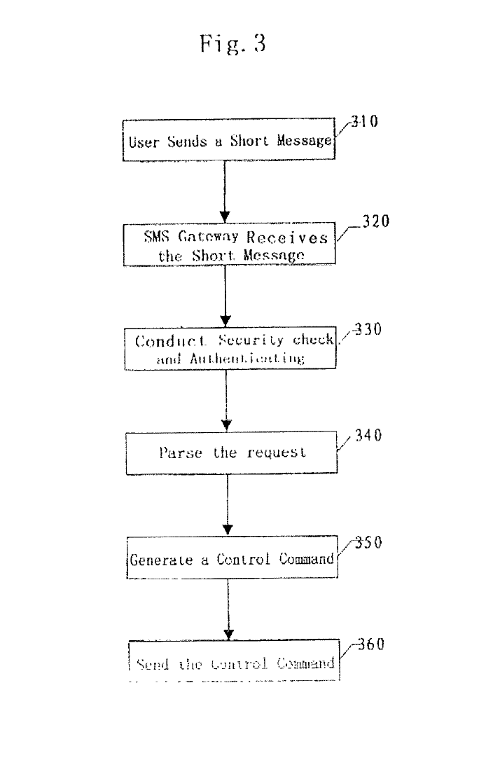

The operation of the system according to an example embodiment of the invention will be described with reference to the flow chart in FIG. 3. As shown in FIG. 3, the method begins in block 310 in which a user sends a short message, for example gON AC 26 h, to a short message gateway. In block 320, the short message gateway receives the short message and the identification (for example, the phone number of a mobile station) of the user who sends the short message. In block 330, the request is authenticated based on the identification of the user. advantageously, if the portable device of the user is attached with a STK card, the short message is firstly decrypted by the security means before the authentication. The short message is authenticated only if it can be correctly decrypted. If the request fails to pass the authentication, such a case will be informed to the user by sending a short message to the user; if the request passes the authentication, the method arrives at block 340 to parse the short message. If the short message fails to be correctly parsed, such a case will be informed to the user by sending a short message to the user; if the short message is correctly parsed, for example, if the request parser correctly understands that the short message means “to turn on the air conditioner and to keep the temperature at 26° C.”, the method arrives at block 350. At block 350, a control demand is generated as a function of the result of the request parser. At block 360, the control command generated at block 350 is sent to the air conditioner.

In other embodiments of the invention, if control command is used to request the target to be controlled to report status of the target, the received status report will be translated into short messages easily understood by the user before being transmitted to the user via the short message gateway. Since the application control server of the invention controls a plurality of apparatus to be controlled, the address of the apparatus to be controlled should be derived when the short message is parsed. For example, in a HIAs case, the address will be a network address. The address will be stored in a map in the database. The address map may be as follows:

| Unique identification | | |
|---|---|---|
| of the user | Name of the device | Address |
| 13901234567 | Ac | Address 1 |
| 13901234567 | Tv | Address 2 |
| 13801234567 | Ac | Address 3 |
| . . . | | |

As such, if the unique identification (such as a telephone number) of the user who sends the short message is 13901234567, the combination of this identification with the name of the device Ac will identify the address of the air conditioner as “address 1”.

To obtain higher security for the system, steps of asking the user to input a name of the user and a password and conducting an authentication maybe included before the user can send a short message according to the method of the invention. Of course, cards such as STK or SMART, JAVA are required in the user side for performing such an operation.

While the invention has been described with reference to particular embodiments, many variations are possible within the scope of the invention as disclosed. For example, in addition to short messages as described in embodiments as above, GPRS (General Packet Radio service) messages and USSD (Unstructured Supplementary Service Data) messages can also be used. Further, though there is a database included in the remote application server, this is for the purpose of a clear logic structure, and in practice, and information stored in the database can be directly incorporated into the programs making use of it respectively.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product including a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

The foregoing has outlined some of the more pertinent objects and embodiments of the present invention. The concepts of the invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

We claim:

1. A remote control system based on a wireless message service, comprising:
transmitting means for transmitting a wireless message and receiving means for receiving the wireless message, and
a control application server which includes security checking means for ensuring safety of the system, command generator for generating a control a command as a function of the received wireless message and communication means for transferring the control command to a device to be controlled.

2. A system as recited in claim 1, wherein said security checking means includes security means and authentication means.

3. A system as recited in claim 2, wherein said authentication means performs authentication as a function of a unique reference number identifying the subscriber transmitting the wireless message.

4. A system as recited in claim 1, wherein said control application server further includes a database for storing information required by operations of the authentication means and the command generator.

5. A system as claimed claim 1, wherein said communication means includes at least one of network communication means, radio communication means, infrared ray communication means and directly wired communication means.

6. A system as recited in claim 1, wherein said wireless message service is a short message service, said receiving means for wireless message is a short message gateway of a short message service center and the short message gateway is connected to the control application service by a wired network.

7. A system as recited in claim 1, wherein said command generator includes means for retrieving the address of the device according to an unique reference number of the subscriber and name of the device.

8. A remote control method based on a wireless message service, comprising the following steps:
transmitting a wireless message; and
receiving the wireless message, further including the steps of checking security properties of the wireless message, generating a control command as a function of the received wireless message and transferring the control command to a device to be controlled.

9. A method as recited in claim 8, wherein said step of checking security includes steps of decrypting and authenticating.

10. A method as recited in claim 9, wherein said step of authenticating includes authenticating according to a unique reference number identifying the device transmitting the wireless message.

11. A method as recited in claim 8, further comprising a step of storing information required by the operations of the step of authenticating and the step of generating a control command.

12. A method as recited in claim 8, wherein said step of transferring the control command to the device to be controlled includes at least one of the following steps: transferring through a network, transferring through wireless channels, transferring through infrared rays channels and transferring through directly wired connections.

13. A method as recited in claim 8, wherein said wireless message includes short messages, the step of receiving said wireless message includes receiving said wireless message by a short message gateway of the short message center and transferring said message to said control application server through a wired network.

14. A method as recited in claim 8, wherein said step of generating control command includes retrieving the address of the device to be controlled as a function of the unique reference number identifying the subscribe and name of the device.

15. An article of manufacture comprising a computer usable medium having computer readable program code means embodied therein for causing a remote control the computer readable program code means in said article of manufacture comprising computer readable program code means for causing a computer to effect the steps of claim 8.

16. A program storage device readable by machine, tangibly embodying a program of instructions executable by the machine to perform method steps for remote control said method steps comprising the steps of claim 8.

17. A computer program product comprising a computer usable medium having computer readable program code means embodied therein for causing remote control the computer readable program code means in said computer program product comprising computer readable program code means for causing a computer to effect the functions of claim 1.
